(19) United States
(12) Patent Application Publication
(10) Pub. No.: US 2021/0208998 A1
(43) Pub. Date: Jul. 8, 2021

(54) FUNCTION ANALYZER, FUNCTION ANALYSIS METHOD, AND FUNCTION ANALYSIS PROGRAM

(71) Applicant: Nippon Telegraph and Telephone Corporation, Tokyo (JP)

(72) Inventor: Takeshi Yamada, Tokyo (JP)

(21) Appl. No.: 17/058,715

(22) PCT Filed: May 24, 2019
(86) PCT No.: PCT/JP2019/020702

§ 371 Date: Nov. 25, 2020

(30) Foreign Application Priority Data
May 29, 2018 (JP) 2018-102430

(51) Int. Cl. G06F 11/36; G06F 11/34; G06F 8/70

(52) U.S. Cl. CPC G06F 11/3612; G06F 8/70; G06F 11/3476; G06F 11/3409

(57) ABSTRACT

To easily estimate an impact evaluation associated with a system transition. A function analysis apparatus 1 includes a call input unit 21 that inputs a call to a call processing system 2, an access log acquisition unit 22 that acquires, when the call processing system 2 processes the call, from a function implementation unit 61 included in the call processing system 2, access log data in which an identifier of the function implementation unit 61 that has accessed data to be evaluated and an identifier of a thread when the data to be evaluated is accessed are associated, and an analysis unit 23 that determines a predetermined function implementation unit 61 as a multi-processing unit when identifiers of a plurality of threads are associated with an identifier of the predetermined function implementation unit 61, and determines the predetermined function implementation unit 61 as a single-processing unit when an identifier of a single thread is associated with the identifier of the predetermined function implementation unit 61.

### TECHNICAL FIELD

The present invention relates to a function analysis apparatus for analyzing a function in a call processing system based on access to data to be evaluated in the call processing system for processing a call from a calling terminal to a called terminal with reference to data, and also relates to a function analysis method, and a function analysis program.

### BACKGROUND ART

A data separation evaluation apparatus is known in which when an application is designed, it is evaluated whether or not to separate data used for the application into an apparatus executing the application and a storage apparatus connected through a communication network, specifically a computer on a cloud (see PTL 1). In PTL 1, for use cases in which data is used and attributes for which data is used in the application, it is determined whether or not to separate data by calculating a score for evaluating whether or not to separate data in terms of an attribute in a use case.

For example, if data is accessed each time a signal is processed in call processing, a problem may occur in real-time processing due to a delay effect, and thus, PTL 1 proposes that data should be retained internally. On the other hand, in a case where data is accessed only once including a case where subscriber information is acquired, PTL 1 proposes that data should be retained externally.

If a system transitions to a data separation type system, processing for accessing to the storage apparatus connected through a communication network is newly added in the applications. Such an access leads to an extension of call processing Turn Around Time (TAT), which may affect system performance. Thus, it is necessary to evaluate an impact associated with the system transition to the data separation type system or the like before a development is determined.

### CITATION LIST

### Patent Literature

PTL 1: JP 2018-25860 A

### SUMMARY OF THE INVENTION

### Technical Problem

Existing systems; however, may be complicated as a result of longstanding development. It is very difficult to estimate an impact evaluation associated with a system transition from documents such as a specification for these existing systems and difficult to obtain suitable determination materials for determining development.

Thus, an object of the present invention is to provide a function analysis apparatus capable of easily estimating an impact evaluation associated with a system transition, and to provide a function analysis method, and a function analysis program.

### Means for Solving the Problem

To solve the above-described problems, a first characteristic of the present invention relates to a function analysis apparatus for analyzing a function in a call processing system based on access to data to be evaluated in the call processing system for processing a call between communication terminals with reference to data. The function analysis apparatus according to the first characteristic of the present invention includes a call input unit configured to input a call to the call processing system, an access log acquisition unit configured to acquire, when the call processing system processes the call, from a function implementation unit included in the call processing system, access log data in which an identifier of the function implementation unit that accesses the data to be evaluated and an identifier of a thread when the data to be evaluated is accessed are associated, and an analysis unit configured to determine a predetermined function implementation unit as a multi-processing unit when identifiers of a plurality of threads are associated with an identifier of the predetermined function implementation unit, and determine a predetermined function implementation unit as a single-processing unit when an identifier of a single thread is associated with the identifier of the predetermined function implementation unit.

The call input unit may continuously input a plurality of calls to the call processing system.

The call input unit may simultaneously input a plurality of calls to the call processing system.

The analysis unit may further calculate the number of times of access to the data to be evaluated in each call.

The access log data may further associate and retain a size of the data to be evaluated accessed by the function implementation unit, and the analysis unit may further calculate a data size of the data to be evaluated accessed in each call.

A second characteristic of the present invention relates to a function analysis method for analyzing a function in a call processing system based on access to data to be evaluated in the call processing system for processing a call between communication terminals with reference to data. The function analysis method according to the second characteristic of the present invention includes, by a computer, inputting a call to the call processing system, by the computer, acquiring, when the call processing system processes the call, from a function implementation unit included in the call processing system, access log data in which an identifier of the function implementation unit that accesses the data to be evaluated and an identifier of a thread when the data to be evaluated is accessed are associated, and, by the computer, determining a predetermined function implementation unit as a multi-processing unit when identifiers of a plurality of threads are associated with an identifier of the predetermined function implementation unit, and determining a predetermined function implementation unit as a single-processing unit when an identifier of a single thread is associated with the identifier of the predetermined function implementation unit.

A third characteristic of the present invention relates to a function analysis program for causing a computer to operate as the function analysis apparatus according to the first characteristic of the present invention.

### Effects of the Invention

According to the present invention, it is possible to provide a function analysis apparatus capable of easily estimating an impact evaluation associated with a system transition, and to provide a function analysis method, and a function analysis program.

### BRIEF DESCRIPTION OF DRAWINGS

FIG. 1 is a diagram for explaining a system configuration of an information processing system and a call processing system according to an embodiment of the present invention.

FIG. 2 is a diagram for explaining an example of a function execution unit that processes a request in the call processing system according to the embodiment of the present invention.

FIG. 3 is a diagram for explaining a hardware configuration and functional blocks of a call processing server according to the embodiment of the present invention.

FIG. 4 is a diagram for explaining a hardware configuration and functional blocks of a function analysis apparatus according to the embodiment of the present invention.

FIG. 5 is a diagram for explaining an example of a thread number used by the function execution unit in the embodiment of the present invention.

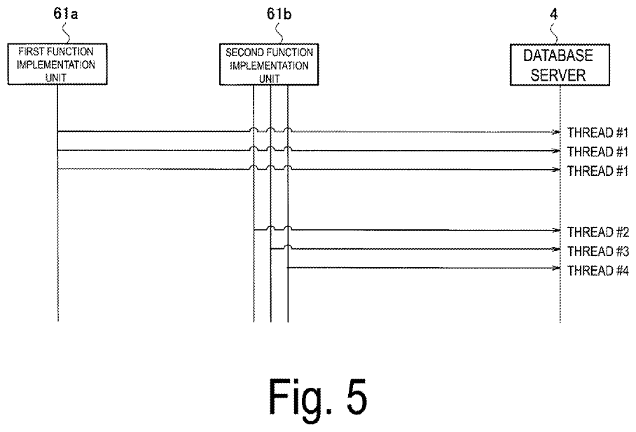

FIG. 6 is a diagram for explaining an example of access log data according to the embodiment of the present invention.

### DESCRIPTION OF EMBODIMENTS

Next, an embodiment of the present invention will be described with reference to the drawings. In the following description regarding the drawings, the same or similar reference signs will be provided to the same or similar components.

Information Processing System

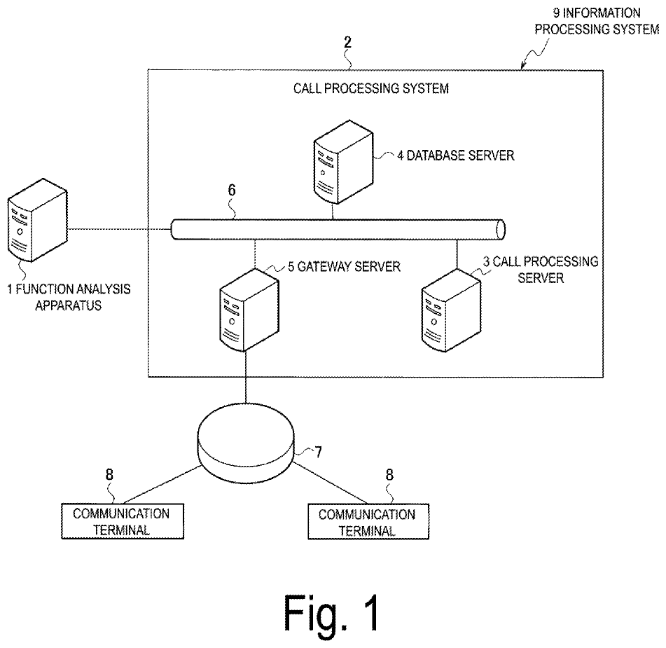

Referring to FIG. 1, an information processing system 9 in which a function analysis apparatus 1 according to the embodiment of the present invention is used will be described. The function analysis apparatus 1 is connected to a call processing system 2 included in the information processing system 9 to analyze a function in the call processing system 2, based on access to data to be evaluated in the call processing system 2. A result of the analysis is used to easily estimate an impact evaluation associated with a system transition.

The call processing system 2 processes a call between communication terminals 8 with reference to data. The call processing system 2 and the communication terminal 8 are communicably connected to each other via a communication network 7 such as the Internet. One of the two communication terminals 8 illustrated in FIG. 1 is a calling terminal, and the other is a called terminal.

The call processing system 2 includes a call processing server 3, a database server 4, and a gateway server 5. The call processing server 3, the database server 4, and the gateway server 5 are communicably connected to each other via a communication network 6 such as a LAN. In the embodiment of the present invention, the function analysis apparatus 1 is connected to the call processing server 3, the database server 4, and the gateway server 5 via the communication network 6, but may be connected in another manner.

Each of the call processing server 3, the database server 4, and the gateway server 5 is a typical computer that includes a storage device, a processing device, and a communication control device. The example illustrated in FIG. 1 explains a case where the call processing server 3, the database server 4, and the gateway server 5 are each composed of one computer, but the present invention is not limited to this. The call processing server 3, the database server 4, and the gateway server 5 may each be composed of a plurality of computers. The functions of the call processing server 3, the database server 4, and the gateway server 5 may be aggregated and implemented in one computer or two computers.

The call processing server 3 processes a call between the communication terminals 8. The call processing server 3 implements functions required for call processing. The database server 4 retains data to be referred to or updated by the call processing server 3, and specifically retains the data to be evaluated. The data to be evaluated is data to be accessed when performance impact described below is calculated, among from data retained by the database server 4. The gateway server 5 serves as an interface between the communication terminal 8 and the call processing system 2.

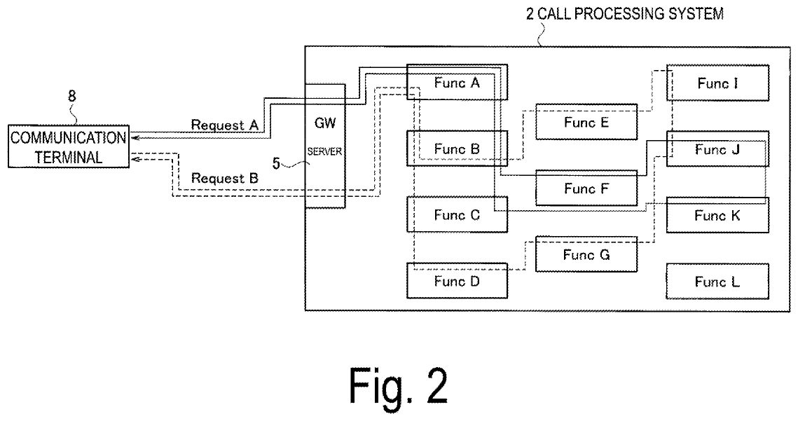

As illustrated in FIG. 2, in the call processing system 2, the gateway server 5 receives a request from the communication terminal 8, and the call processing server 3 implements various functions to process the request, and then a processing result is returned to the communication terminal 8. A plurality of functions such as FuncA and FuncB in FIG. 2, illustrated in the call processing system 2 of FIG. 2 are implemented by the call processing server 3 and are components such as a program and a module of software.

In the call processing system 2, functions of processing a request vary depending on a type or the like of the request transmitted from the communication terminal 8. For example, a request A illustrated in FIG. 2 is processed by function implementation units for FuncA, FuncB, FuncF, FuncJ, FuncK, FuncC, FuncB, and FuncA, in this order. A request B is processed by function implementation units for FuncA, FuncB, FuncE, FuncI, FuncJ, FuncG, FuncD, FuncC, FuncB, and FuncA, in this order. At this time, each of the function implementation units of the call processing server 3 implements a predetermined function with reference to the data in the database server 4.

The performance impact due to data separation is represented by delay, and affects independent delay such as delay due to size and delay due to access frequency. Thus, the performance impact for the access to the data to be evaluated in the database server 4 by the function execution unit employed in the call processing system 2 is evaluated by expression (1).

Performance Impact∝Access Frequency [times/sec]×Size [Byte]∝Access Frequency [times/call]×Traffic Density [call/sec]×Size [Byte]×Timer Value [sec] Expression (1)

Here, if the function execution unit that accesses the database server 4 has one thread, and the one thread includes single-processing in which different requests are sequentially processed, the performance impact is evaluated by expression (2).

Performance Impact∝Access Frequency [times/call]×Traffic Density [call/sec]×Size [Byte]×Timer Value [sec] Expression (2)

On the other hand, if the function execution unit that accesses the database server 4 includes a plurality of threads, and the plurality of threads include multi-processing in which different requests are sequentially processed in parallel, the performance impact is evaluated by expression (3).

Performance Impact∝Access Frequency [times/call]×Size [Byte] Expression (3)

In order to measure the performance impact for the access to the data to be evaluated by the software, according to the above-described expressions, it is necessary to specify an access frequency [times/sec], a traffic density [call/sec], a size [Byte], a timer value [sec], and a software structure. The access frequency [times/sec] is the number of times of access to the data to be evaluated in each call. The traffic density [call/sec] is an amount of operational traffic of the call in the call processing system 2. The size [Byte] is a size of the data to be evaluated to be accessed in each call. The timer value [sec] is a time required for processing causing a bottleneck in the access to the data to be evaluated. The software structure is an indicator of single-processing or multi-processing.

Among the above-described conditions, the traffic density [call/sec] and the timer value [sec] can be acquired in advance from requirements and the like of the software. Thus, the function analysis apparatus 1 according to the embodiment of the present invention causes the call processing system 2 to process a request, and acquires, from log data, the access frequency [times/sec], the size [Byte], and the software structure.

Call Processing Server

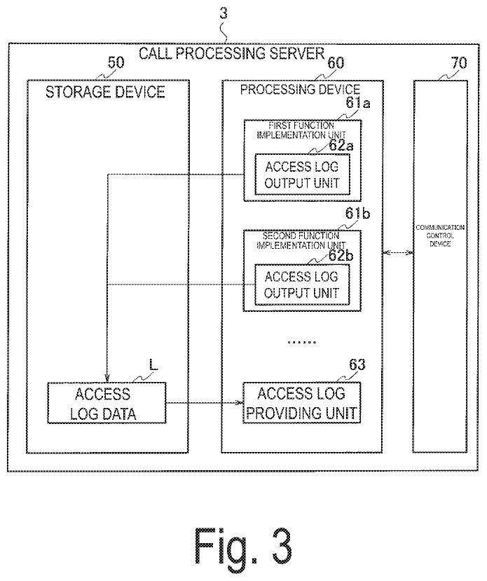

Referring to FIG. 3, the call processing server 3 according to the embodiment of the present invention will be described. The call processing server 3 is a typical computer that includes a storage device 50, a processing device 60, and a communication control device 70. The functions illustrated in FIG. 3 are implemented by the typical computer executes a call processing program.

The storage device 50 is a Read Only Memory (ROM), a Random Access Memory (RAM), a hard disk, or the like and stores various kinds of data such as input data, output data, and intermediate data for the processing device 60 executing processing. The processing device 60 is a Central Processing Unit (CPU) and executes processing in the call processing server 3 by reading and writing data stored in the storage device 50 and inputting and outputting data to and from the communication control device 70. The communication control device 70 is an interface for connecting the call processing server 3 to the gateway server 5 and the database server 4.

The storage device 50 stores access log data L. The access log data L is log data indicating the access to the data to be evaluated in the database server 4 by a function implementation unit 61 included in the call processing server 3.

The processing device 60 includes a plurality of function implementation units 61, such as a first function implementation unit 61a and a second function implementation unit 61b, and an access log providing unit 63.

The plurality of function implementation units 61, such as the first function implementation unit 61a and the second function implementation unit 61b each implement a given function such as FuncA. FuncB, and the like illustrated in FIG. 2, required for the call processing. In the example illustrated in FIG. 3, only two function implementation units 61 are illustrated, but the call processing server 3 may include a plurality of function implementation units 61 depending on functions implemented by the call processing system 2.

The first function implementation unit 61a and the second function implementation unit 61b respectively include an access log output unit 62a and an access log output unit 62b. Another function implementation unit also includes an access log output unit 62. The access log output unit 62 writes a log in the access log data L when the data to be evaluated in the database server 4 is accessed. The access log output unit 62 outputs, to the access log data L, a record in which an identifier of the function implementation unit 61 that has accessed the data to be evaluated, an identifier of the accessed data to be evaluated, a size of the data to be evaluated, a time, a thread number in which the data to be evaluated is accessed, and the like are associated.

Each of the function implementation units 61 accesses the data to be evaluated in single-processing or multi-processing. If the function implementation unit 61 implements single-processing, a thread number in which the data to be evaluated has been accessed is same. If the function implementation unit 61 implements multi-processing, a thread number assigned to a thread in which the data to be evaluated has been accessed, for example, may be assigned with a lower number out of available thread numbers or may be constantly changed in a round-robin fashion.

The access log providing unit 63 provides the function analysis apparatus 1 with the access log data L. The access log providing unit 63 may provide the function analysis apparatus 1 with the access log data L in response to a request from the function analysis apparatus 1, or may provide the function analysis apparatus 1 with the access log data L at a predetermined timing.

Function Analysis Apparatus

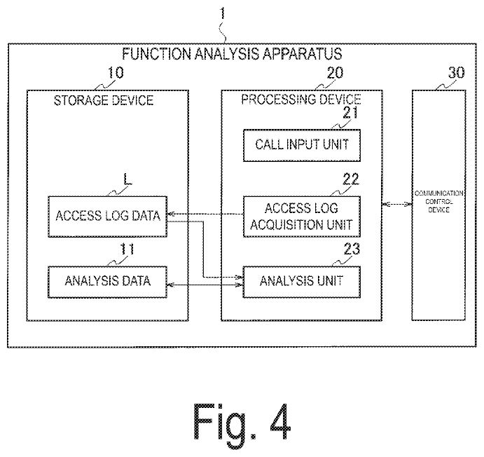

Referring to FIG. 4, the function analysis apparatus 1 according to the embodiment of the present invention will be described. The function analysis apparatus 1 is a typical computer that includes a storage device 10, a processing device 20, and a communication control device 30. The functions illustrated in FIG. 4 are implemented by the typical computer executing a function analysis program.

The storage device 10 is a Read Only Memory (ROM), a Random Access Memory (RAM), a hard disk, or the like and stores various kinds of data such as input data, output data, and intermediate data for the processing device 20 executing processing. The processing device 20 is a Central Processing Unit (CPU) and executes processing in the function analysis apparatus 1 by reading and writing data stored in the storage device 10 and inputting and outputting data to and from the communication control device 30. The communication control device 30 is an interface for connecting the function analysis apparatus 1 to the call processing server 3.

The access log data L is data acquired from the call processing server 3. If the call processing system 2 includes a plurality of call processing servers 3, the access log data L is data obtained by merging access log data acquired from each of the call processing servers 3.

Analysis data 11 includes a result of analyzing each of the function execution units from the access log data L by the function analysis apparatus 1. In the embodiment of the present invention, the analysis data 11 includes each of values of the access frequency [times/sec], the size [Byte], and the software structure indicating single-processing or multi-processing, for calculating the performance impact explained by the above-described expressions (1) to (3).

The processing device 20 includes a call input unit 21, an access log acquisition unit 22, and an analysis unit 23.

The call input unit 21 inputs a call to the call processing system 2. The call to be input here may be a test call, not an actual call. The call input unit 21 continuously or simultaneously inputs a plurality of calls to determine whether the function implementation unit 61 implements the multi-processing or the single-processing.

The call input unit 21 continuously inputs a plurality of calls to the call processing system 2. In a case where a thread number assigned to a thread corresponding to the function implementation unit 61 implementing multi-processing is constantly changed in a round-robin fashion, if a plurality of calls are continuously input, then a new call is input before the processing of the call that has been input immediately before is completed, a different thread number is assigned to the thread. This indicates that in the access log data L, different thread numbers are assigned to a plurality of thread numbers corresponding to a certain function implementation unit 61, and thus, the certain function implementation unit 61 implements multi-processing.

The call input unit 21 simultaneously inputs a plurality of calls to the call processing system 2. If a lower number out of available thread numbers is assigned to the thread corresponding to the function implementation unit 61 implementing multi-processing, different thread numbers are assigned to threads by simultaneously inputting the plurality of calls. This indicates that in the access log data L, different thread numbers are assigned to a plurality of thread numbers corresponding to a certain function implementation unit 61, and thus, the certain function implementation unit 61 implements the multi-processing.

The access log acquisition unit 22 acquires the access log data L from the call processing server 3. If the call processing system 2 includes a plurality of call processing servers 3, the access log acquisition unit 22 stores, into the storage device 10, the access log data L obtained by merging access log data acquired from each of the call processing servers 3.

The analysis unit 23 analyzes, from the access log data L, the access frequency [times/sec], the size [Byte], and the software structure indicating single-processing or multi-processing, for calculating the performance impact explained by the above-described expressions (1) to (3), and outputs the analysis data 11.

When the software structure is specified, the access log acquisition unit 22 acquires, when the call processing system 2 processes a call, from the plurality of function implementation units 61 included in the call processing system 2, the access log data L in which at least an identifier of the function implementation unit 61 that has accessed the data to be evaluated and an identifier of a thread in which the data to be evaluated has been accessed are associated. If identifiers of a plurality of threads are associated with an identifier of a predetermined function implementation unit, the analysis unit 23 determines the predetermined function implementation unit 61 as a multi-processing unit, and if an identifier of a single thread is associated, the analysis unit 23 determines the predetermined function implementation unit 61 as a single-processing unit.

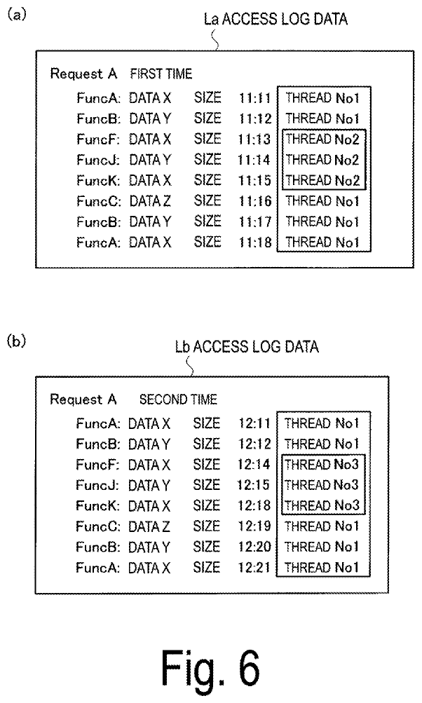

For example, as illustrated in FIG. 6, it is assumed that there has been access to the data to be evaluated in the database server 4 from each of the first function implementation unit 61a and the second function implementation unit 61b. Even if a plurality of accesses are input simultaneously or continuously, a thread used for the access from the first function implementation unit 61a is a thread #1, that is, the thread number is the same. Thus, the analysis unit 23 determines that the first function implementation unit 61a implements single-processing.

On the other hand, if a plurality of pieces are input simultaneously or continuously, a thread used for the access from the first function implementation unit 61a is a thread #2, a thread #3, and a thread 4, that is, the thread numbers are different. Thus, the analysis unit 23 determines that the second function implementation unit 61b implements single-processing.

The processing of the analysis unit 23 will be described with reference to the access log data L illustrated in FIG. 6. FIG. 6(a) illustrates access log data La acquired from each of the function implementation units 61 when the request A is input for the first time, and FIG. 6(b) illustrates access log data Lb acquired from each of the function implementation units 61 when the request A is input for the second time.

A thread number used by each of FuncA, FuncB, and FuncC in the access log data La, and a thread used by each of FuncA, FuncB, and FuncC in the access log data Lb are assigned the same thread number “thread No1”, and the same thread number is used. Thus, it is determined that FuncA, FuncB, and FuncC has a single-processing structure.

On the other hand, a thread used by each of FuncF, FuncJ, and FuncK in the access log data La is assigned a thread number “thread No2” while a thread used by each of FuncF, FuncJ, and FuncK in the access log data Lb is assigned a thread number “thread No3.” that is, different thread numbers are used. Thus, it is determined that FuncF, FuncJ, and FuncK has a multi-processing structure.

When the access frequency is specified, the analysis unit 23 calculates, from the access log data L, the number of times of access to the data to be evaluated in each call. The analysis unit 23 calculates, for example, from the log data illustrated in FIG. 6(a), that the number of times of access to data X to be evaluated is four.

When the traffic density is specified, the access log acquisition unit 22 acquires the access log data L in which the size of the data to be evaluated accessed by the function implementation unit 61 is further associated with an identifier of the function implementation unit 61 that has accessed the data to be evaluated and an identifier of a thread when the data to be evaluated has been accessed. The analysis unit 23 refers to the access log data L to calculate a data size of the access to the data to be evaluated in each call.

The access frequency [times/sec], the size [Byte], and the software structure indicating single-processing or multi-processing calculated by the analysis unit 23 as described above are used to calculate evaluation impact represented by the expressions (1) to (3). The evaluation impact calculated as described above serves as an indicator of the impact evaluation associated with the system transition to the data separation system.

If a plurality of calls are input simultaneously or continuously, then conversion of the thread number when the data to be evaluated has been accessed is observed, it is determine whether the function implementation unit 61 corresponding to the thread implements single-processing or multi-processing, without referring to a specification or the like.

### OTHER EMBODIMENTS

Although the embodiment of the present invention has been described above, it should not be understood that description and drawings that are parts of the disclosure are intended to limit the present invention. Various alternative embodiments, examples, and running techniques will become apparent from the disclosure for those skilled in the art.

For example, the function analysis apparatus described in the embodiment of the present invention may be configured on a single piece of hardware as illustrated in FIG. 4 or may be configured on a plurality of pieces of hardware in accordance with functions and the number of processes thereof. The function analysis apparatus may be implemented on a known information processing system.

It is a matter of course that various embodiments and the like that are not described herein are also included in the present invention. Therefore, the technical scope of the present invention is defined merely by specific matters of the present invention related to the scope of aspects that is reasonable from the above description.

### REFERENCE SIGNS LIST

1 Function analysis apparatus
2 Call processing system
3 Call processing server
4 Database server
5 Gateway Server
6, 7 Communication network
8 Communication terminal
9 Information processing system
10, 50 Storage device
11 Analysis data
20, 60 Processing device
21 Call input unit
22 Access log acquisition unit
23 Analysis unit
61 Function implementation unit
62 Access log output unit
63 Access log providing unit
L Access log data

1. A function analysis apparatus for analyzing a function in a call processing system based on access to data to be evaluated in the call processing system for processing a call between communication terminals with reference to data, the function analysis apparatus comprising:
a call input unit, including one or more processors, configured to input a call to the call processing system;
an access log acquisition unit, including one or more processors, configured to acquire, when the call processing system processes the call, from a function implementation unit, including one or more processors, included in the call processing system, access log data in which an identifier of the function implementation unit that accesses the data to be evaluated and an identifier of a thread when the data to be evaluated is accessed are associated; and
an analysis unit, including one or more processors, configured to determine a predetermined function implementation unit as a multi-processing unit when identifiers of a plurality of threads are associated with an identifier of the predetermined function implementation unit, and determine a predetermined function implementation unit as a single-processing unit when an identifier of a single thread is associated with the identifier of the predetermined function implementation unit.

2. The function analysis apparatus according to claim 1, wherein the call input unit continuously inputs a plurality of calls to the call processing system.

3. The function analysis apparatus according to claim 1, wherein the call input unit simultaneously inputs a plurality of calls to the call processing system.

4. The function analysis apparatus according to claim 1, wherein the analysis unit further calculates a number of times of access to the data to be evaluated in each call.

5. The function analysis apparatus according to claim 1, wherein the access log data further associates and retains a size of the data to be evaluated accessed by the function implementation unit, and
the analysis unit further calculates a data size of the data to be evaluated accessed in each call.

6. A function analysis method for analyzing a function in a call processing system based on access to data to be evaluated in the call processing system for processing a call between communication terminals with reference to data, the function analysis method comprising:
by a computer, inputting a call to the call processing system;
by the computer, acquiring, when the call processing system processes the call, from a function implementation unit, including one or more processors, included in the call processing system, access log data in which an identifier of the function implementation unit that accesses the data to be evaluated and an identifier of a thread when the data to be evaluated is accessed are associated; and
by the computer, determining a predetermined function implementation unit as a multi-processing unit when identifiers of a plurality of threads are associated with an identifier of the predetermined function implementation unit, and determining a predetermined function implementation unit as a single-processing unit when an identifier of a single thread is associated with the identifier of the predetermined function implementation unit.

7. A non-transitory computer readable medium storing one or more instructions for analyzing a function in a call processing system based on access to data to be evaluated in the call processing system for processing a call between communication terminals with reference to data, the one or more instructions causing a computer to execute:
by the computer, inputting a call to the call processing system;
by the computer, acquiring, when the call processing system processes the call, from a function implementation unit, including one or more processors, included in the call processing system, access log data in which an identifier of the function implementation unit that accesses the data to be evaluated and an identifier of a thread when the data to be evaluated is accessed are associated; and
by the computer, determining a predetermined function implementation unit as a multi-processing unit when identifiers of a plurality of threads are associated with an identifier of the predetermined function implementation unit, and determining a predetermined function implementation unit as a single-processing unit when an identifier of a single thread is associated with the identifier of the predetermined function implementation unit.

8. The function analysis method according to claim 6, further comprising:
by the computer, continuously inputting a plurality of calls to the call processing system.

9. The function analysis method according to claim 6, further comprising:
by the computer, simultaneously inputting a plurality of calls to the call processing system.

10. The function analysis method according to claim 6, further comprising:
by the computer, calculating a number of times of access to the data to be evaluated in each call.

11. The function analysis method according to claim 6, wherein the access log data further associates and retains a size of the data to be evaluated accessed by the function implementation unit, and
the method further comprising:
by the computer, calculating a data size of the data to be evaluated accessed in each call.

12. The non-transitory computer readable medium according to claim 7, wherein the one or more instructions further cause the computer to execute:
by the computer, continuously inputting a plurality of calls to the call processing system.

13. The non-transitory computer readable medium according to claim 7, wherein the one or more instructions further cause the computer to execute:
by the computer, simultaneously inputting a plurality of calls to the call processing system.

14. The non-transitory computer readable medium according to claim 7, wherein the one or more instructions further cause the computer to execute:
by the computer, calculating a number of times of access to the data to be evaluated in each call.

15. The non-transitory computer readable medium according to claim 7, wherein the access log data further associates and retains a size of the data to be evaluated accessed by the function implementation unit, and
wherein the one or more instructions further cause the computer to execute:
by the computer, calculating a data size of the data to be evaluated accessed in each call.
